(19) United States
(12) Patent Application Publication
(10) Pub. No.: US 2023/0311566 A1
(43) Pub. Date: Oct. 5, 2023

(54) WHEEL STRUCTURE WITH BUILT-IN REDUCER AND MOTOR

(71) Applicant: BEIHANG UNIVERSITY, Beijing (CN)

(72) Inventors: Juan CHEN, Beijing (CN); Jingkun WEI, Beijing (CN); Qingzhen ZHANG, Beijing (CN); Langfu CUI, Beijing (CN); Changlin WU, Beijing (CN); Shicheng ZHENG, Beijing (CN); Yongling FU, Beijing (CN)

(73) Assignee: BEIHANG UNIVERSITY, Beijing (CN)

(21) Appl. No.: 18/127,689

(22) Filed: Mar. 29, 2023

(30) Foreign Application Priority Data
Mar. 29, 2022 (CN) 202210341626.3

(51) Int. Cl. B60B 27/00; B60K 7/00; B60K 17/04

(52) U.S. Cl. CPC B60B 27/0047; B60B 27/0031; B60K 7/0007; B60K 17/046; B60B 1/06

(57) ABSTRACT

A wheel structure with a built-in reducer and motor is provided. As the driving wheel in a rudder wheel, which has a high degree of integration and significantly reduces the overall height of the rudder wheel while maintaining high speed and acceleration. The wheel structure includes a wheel coupled to a reducer, a drive motor connected to the reducer, and the reducer.

### CROSS REFERENCE TO THE RELATED APPLICATIONS

This application is based upon and claims priority to Chinese Patent Application No. 202210341626.3, filed on Mar. 29, 2022, the entire contents of which are incorporated herein by reference.

### TECHNICAL FIELD

The present invention belongs to the field of robotics and specifically relates to a wheel structure with a built-in reducer and motor, which is small and highly integrated.

### BACKGROUND

In an omnidirectional mobile robot chassis, the rudder wheel has two degrees of freedom: rudder rotation changes the direction of wheel rotation, allowing the robot chassis to move omnidirectionally while still having high speed and acceleration, making it an excellent performer in robotics competitions.

The lower the chassis, the better the stability and maneuverability, and the compact design of the rudder wheel provides the robot with more space and space on the upper floor, extending the functional components and applications of the robot. However, existing rudder wheels have been designed to be too tall and take up too much space, due to the overall size and height of the drive wheel part of the rudder for forward motion. Some rudders use a large diameter hub motor directly connected to the drive wheel, resulting in a large diameter design, while other rudders use a small diameter motor as the drive wheel motor, but inevitably the reducer is positioned above, also resulting in excessive height.

### SUMMARY

In response to the above-mentioned problems with the main drive wheel part of the rudder wheel design, the present invention proposes a wheel structure with a built-in reducer and motor. As the driving wheel in the rudder wheel, it has a high degree of integration and significantly reduces the overall height of the rudder wheel while maintaining high speed and acceleration.

A wheel structure with built-in reducer and motor, including a wheel, drive motor and reducer.

The wheel consists of a hub and a tyre. The hub is a hollow structure with an offset “I” shape in cross-section and vertical spokes in the middle offset to provide strength support. The spokes divide the space inside the wheel into two different volumes, left and right, to house the drive motor and reducer respectively. The inner cavity of the wheel increases in diameter from the inside to the outside, providing space for the motor and reducer to be mounted while increasing the assembly clearance; the outer cylindrical surface of the wheel has grooves for bonding the tyres. The tyres are hot-melt bald tyres with a high coefficient of friction.

The drive motor is a small-diameter, high-power motor arranged in a voluminous internal cavity in the hub.

The reducer is a planetary reducer, including a wheel gear ring holder, a gear ring bearing, an inner gear ring, a gear ring holder, a wheel planetary holder, an outer planetary holder, a sun gear, a retaining ring, a sun gear shaft, a motor output shaft, a pressure plate, a key, a planetary holder flange bearing, a gear ring holder flange bearing, a planetary gear shaft, a planetary gear flange bearing, a planetary gear and a wheel flange bearing. The motor output shaft of the drive motor is connected to the sun gear shaft by pressing the D-shaped shaft located at its end through a pressure plate, and the sun gear shaft is connected to the sun gear co-axially through a key, and the sun gear end face is provided with an axially constrained retaining ring; the outer planetary holder and the wheel planetary holder are connected to the hub through countersunk screws, and the planetary gear is constrained to the planetary gear shaft through two planetary gear flange bearings, and the planetary gear shaft is connected to the outer planetary holder and the planetary gear is restrained between the outer planetary gear and the wheel planetary gear by two planetary gear flange bearings, the planetary gear shaft is connected to the outer planetary gear and the wheel planetary gear, and the planetary gear is restrained between the outer planetary gear and the wheel planetary gear. The inner gear ring and wheel gear ring holder are attached to the ring mounting bracket by means of hexagon socket screws.

The hub is coaxially bound to the motor output shaft via the wheel flange bearing, the wheel ring holder is coaxially bound to the wheel planetary holder via the ring bearing, the outer planetary holder is coaxially bound to the sun gear shaft via the planetary holder flange bearing, and the sun gear shaft is coaxially bound to the gear ring holder via the ring holder flange bearing.

The planetary reducer has an inner gear ring as the fixed end, a sun gear as the input end and a wheel planetary holder as the output end. The sun gear engages with the planetary gear and the planetary gear engages with the inner gear ring, driving the planetary gear forward when the sun gear rotates on the fixed inner gear ring, driving the wheel planetary holder coaxially to the sun gear to decelerate the output. The input end of the planetary gear is connected to the drive motor, the output end is connected to the wheel, and the fixed end is used as the support for the reducer.

The width of a single tyre is set to a, and the hub needs to be arranged with K tyres, so the hub width is A=ka (k is a positive integer); the hub width A needs to be designed so that the motor rotor and reducer are arranged in the hub, and the unused space in the hub is minimised.

The outer hub size is designed to match the tyre size. The hub width is designed taking into account the tyre width, the drive motor width and the reducer width.

The outer dimensions of the hub should match the inner diameter of the tyre, set this diameter as D; the maximum diameter of the inner cavity of the hub is d₁, the minimum diameter is d₂ and the maximum diameter of the drive motor rotor is d.

D>d1>d2>d;

Considering the larger and wider space occupied by the motor in the hub cavity, as a result, the cantilever on the hub motor side is larger than the cantilever on the reducer side. The deformation is also the greatest, with the greatest deformation occurring at the outermost end of the cantilever on the hub motor side.

Set the initial clearance at this point u=d₁−d.

When the wheel is deformed by the forces, the clearance should always be greater than zero, i.e. the maximum deformation of the wheel u₁<u.

The choice of high-strength materials allows the deformation to be reduced, thus reducing the initial clearance u. By means of the constraints of the above equations, the wheel cavity diameter and the wheel material are optimally designed in a comprehensive manner. Analysis of wheel forces by finite element analysis and selection of suitable wheel materials to meet the constraint requirements.

The wheel structure with integrated reducer and drive motor is externally connected by means of threads on the end of the drive motor and threads on the gear ring mount. As two support points for the wheel structure integral with built-in reducer and motor, the two support points are on the outermost side of the wheel structure integral with built-in reducer and motor, making it a support in the form of a simple beam structure with high load-bearing capacity.

Compared to the prior art, the advantages of the present invention are: the wheel structure with built-in reducer and motor is highly integrated, compact and takes up less space. The motor is output to the wheel after deceleration through the reducer, resulting in a high driving torque on the wheel. The tyres are made of bald thermoplastic tyres with high friction on dry ground and the wheels have a wide overall width and high load capacity.

### BRIEF DESCRIPTION OF THE DRAWINGS

FIG. 1 shows a diagram of the overall structure of a wheel with a built-in reducer and motor

FIG. 2 shows a cross-sectional view of the hub of the wheel structure with built-in reducer and motor

FIG. 3 shows an axonometric view of the hub of the wheel structure with built-in reducer and motor.

FIG. 4 shows a sectional view of the reducer of the wheel structure with built-in reducer and motor

FIG. 5 shows a finite element analysis stress diagram of the hub of the wheel structure with built-in reducer and motor.

FIG. 6 shows the FEA displacement diagram of the wheel structure with built-in reducer and motor.

In the drawing. 1 is the wheel, 1-1 is the hub, 1-1-1 is the outer hub, 1-1-2 is the spokes, 1-1-3 is the inner hub cavity, 1-1-4 is the recess, 1-2 is the tyre; 2 is the drive motor; 3 is the reducer, 3-1 is the wheel gear ring holder, 3-2 is the ring bearing, 3-3 is the inner gear ring, 3-4 is the socket head screw, 3-5 is the gear ring holder, 3-6 is the wheel planetary holder, 3-7 for outer planetary holder, 3-8 for countersunk screw, 3-9 for sun gear, 3-10 for retaining ring, 3-11 for the sun gear shaft, 3-12 for the motor output shaft, 3-13 for the pressure plate, 3-14 for the key, 3-15 for the planetary holder flange bearing, 3-16 for the ring holder flange bearing, 3-17 for the planetary gear shaft, 3-18 for the planetary gear flange bearing, 3-19 for the planetary gear, and 3-20 for the wheel flange bearing.

### DETAILED DESCRIPTION OF THE EMBODIMENTS

The present invention is described in further detail below in conjunction with the accompanying drawings and specific examples:

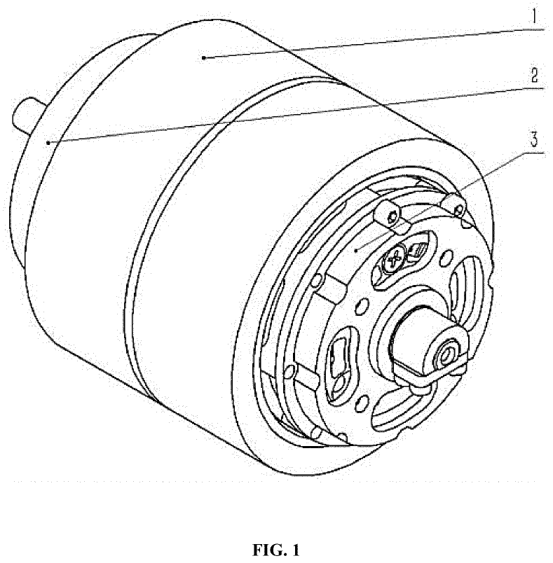

The present invention a wheel structure with a built-in reducer and motor, including a wheel 1, a drive motor 2 and a reducer 3, as shown in FIG. 1.

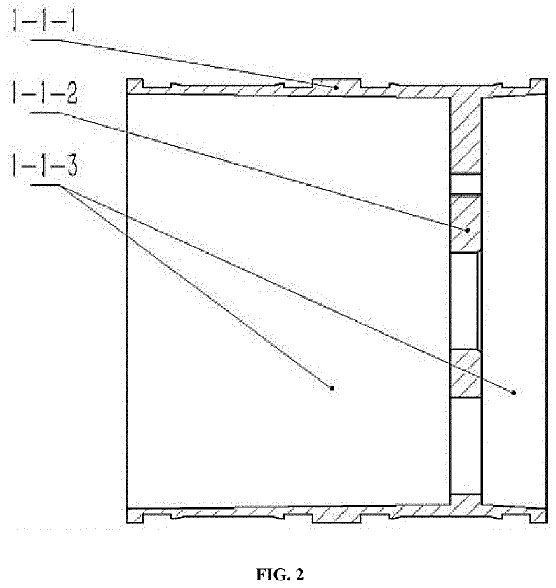

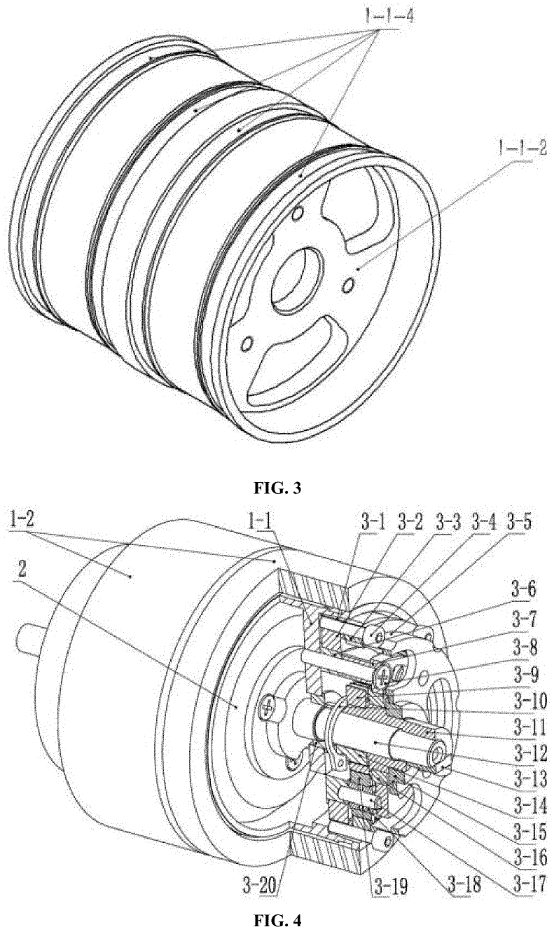

The wheel 1 includes a hub 1-1 and a tyre 1-2. The hub 1-1 is a hollow structure with an “I” shape cross-section and vertical spokes 1-1-2 offset in the middle to provide strength support; the spokes 1-1-2 divide the space inside the wheel 1 into two different volume spaces 1-1-3 on the left and right side of the hub, where the drive motor 2 and the reducer 3 are placed respectively. The inner diameter of the wheel cavity 1-1-3 gradually increases from the inside to the outside, providing space for the motor 2 and reducer 3 to be installed while increasing the assembly clearance; the upper and lower horizontal part of the “I” is the wheel outer rim 1-1-1, which is cylindrical in shape and has grooves 1-1-4 on its surface for bonding with the tyre 1-2, as shown in FIGS. 2 and 3. Tyre 1-2 is a hot-melt bald-head tyre, an existing product with a width of 26 mm, an outer diameter of 66 mm and an inner diameter of 54 mm, with a high coefficient of friction.

The drive motor 2 is a small diameter, high power motor, providing a sufficient power source for wheel 1, arranged on the side of the larger spokes 1-1-2 in the inner cavity 1-1-3 of the wheel.

The reducer 3 of the wheel is a planetary reducer including a wheel gear ring holder 3-1, a gear ring bearing 3-2, an inner gear ring 3-3, a gear ring holder 3-5, a wheel planetary holder 3-6, an outer planetary holder 3-7, a sun gear 3-9, a retaining ring 3-10, a sun gear shaft 3-11, a motor output shaft 3-12, a pressure plate 3-13, a key 3-14, a planetary holder flange bearing 3-15, a gear ring holder flange bearing 3-16, planetary gear shaft 3-17, planetary gear flange bearing 3-18, planetary gear 3-19 and wheel flange bearing 3-20, etc. The motor output shaft 3-12 of the drive motor 2 is connected to the sun gear shaft 3-11 by pressing the D-shaped shaft located at its end through the pressure plate 3-13, and the sun gear shaft 3-11 is connected to the sun gear 3-9 co-axially through the key 3-14, and the sun gear 3-9 is provided with an axially restrained retaining ring 3-10 on its end face; the outer planetary holder 3-7 and the wheel planetary holder 3-6 are connected to the hub 1—through the countersunk head screw 3-8, and the planetary gear 3-7 and the wheel flange bearing 3-6 are connected to the hub 1 The planetary gear 3-19 is restrained on the planetary gear shaft 3-17 by two planetary gear flange bearings 3-18, and the planetary gear shaft 3-17 is connected to the outer planetary holder 3-7 and the wheel planetary holder 3-6, and the planetary gear 3-19 is restrained to move between the outer planetary holder 3-7 and the wheel planetary holder 3-6; the inner gear ring 3-3 and the wheel gear ring holder 3-1 are connected by hexagonal screws 3-4 to the gear ring holder 3-5.

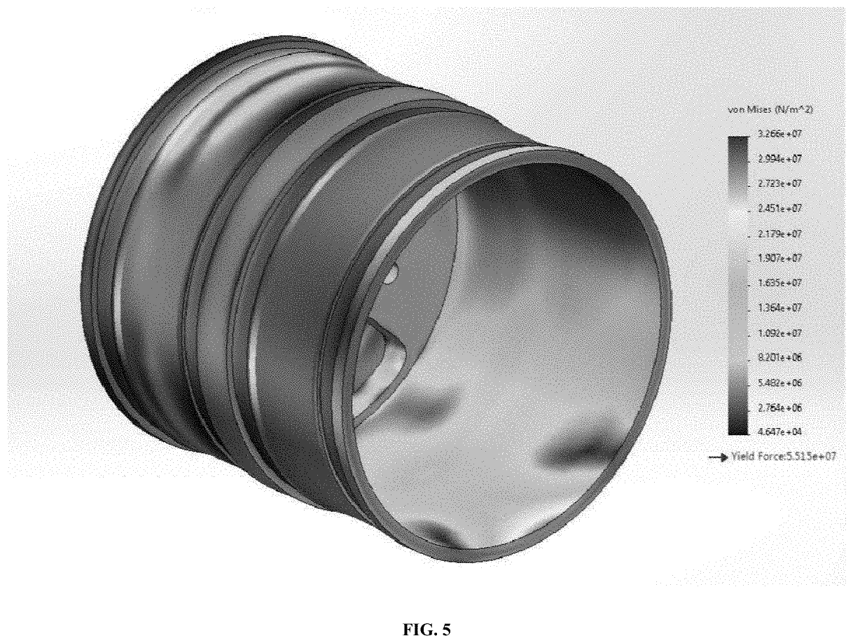

Hub 1-1 is coaxially bound to motor output shaft 3-12 via wheel flange bearing 3-20, wheel ring holder 3-1 is coaxially bound to wheel planetary holder 3-6 via ring bearing 3-2, outer planetary holder 3-7 is coaxially bound to sun gear shaft 3-11 via planetary holder flange bearing 3-15, sun gear shaft 3-11 is coaxially bound to gear ring through ring holder flange bearing 3-16, as shown in FIG. 4.

The planetary reducer has the inner gear ring 3-3 as the fixed end, the sun gear 3-9 as the input end and the wheel planetary holder 3-6 as the output end, the sun gear 3-9 engages with the planetary gear 3-19, the planetary gear 3-19 engages with the inner gear ring 3-3, the sun gear 3-9 rotates to drive the planetary gear 3-19 to rotate forward on the fixed inner gear ring 3-3, driving the wheel planetary holder 3-6 coaxially to the sun gear 3-9 deceleration output. The input end of the planetary reducer is connected to the drive motor 2, the output end is connected to the wheel 1 and the fixed end serves as a support for the reducer 3.

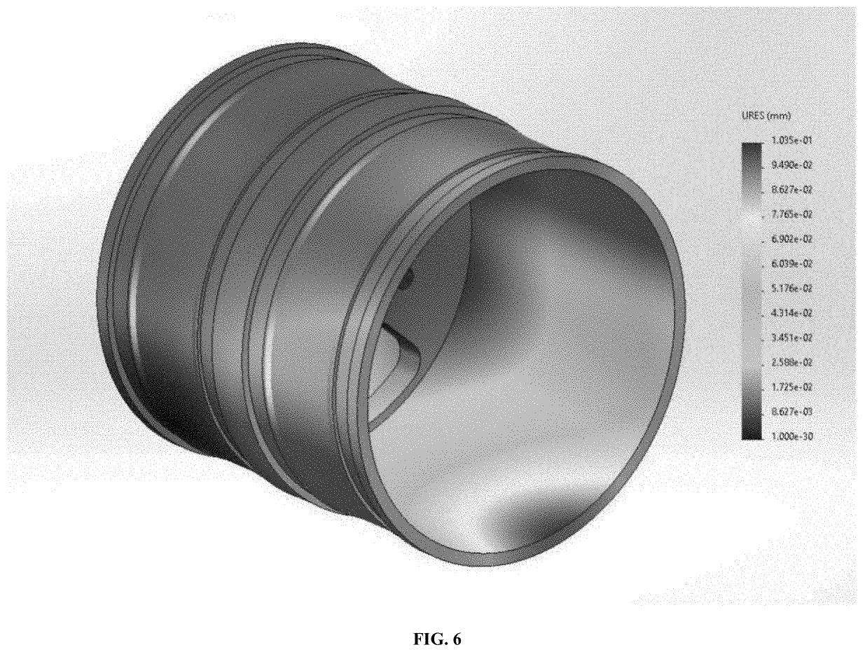

The outer rim of the wheel 1-1-1 is designed to match the size of tyre 1-2. The width of hub 1-1 is designed taking into account the width of tyre 1-2, the width of drive motor 2 and the width of reducer 3. The width of a single tyre 1-2 is 26 mm, and the lateral arrangement of two tyres 1-2 brings the total width of the wheel to 52 mm, which is the width for the drive motor 2 and reducer 3 to be set in the wheel cavity 1-1-3 and just fill the wheel cavity 1-1-3 in a compact layout. In this example, the drive motor 2 has a diameter of 50 mm and the hub cavity 1-1-3 has a diameter of 51 to 52.5 mm widened from the inside to the outside, with a maximum clearance of 1 0.25 mm between the drive motor 2 and the hub cavity 1-1-3. analysis of the forces on hub 1-1, as shown in FIGS. 5 and 6. The design weight of a robot is 50 kg and the number of wheels is 4. Therefore, the force on a single wheel is 15 kgf. Aluminium alloy is chosen as the material of hub 1-1. Under this force condition, the maximum stress of hub 1-1 is less than the yield strength of the material, and the maximum deformation is less than the gap between the drive motor 2 and the inner cavity of hub 1-1-3, meeting the strength and deformation requirements of the material.

The wheel integral with built-in reducer and drive motor is connected to the outside through the threads at the end of the drive motor 2 and the threads of the gear ring holder 3-5 as two support points for the wheel structure integral with built-in reducer and motor. The two support points are on the outermost side of the wheel structure integral with built-in reducer and motor, making it a simple beam structure support with high load carrying capacity.

What is claimed is:

1. A wheel structure with a built-in reducer and motor, comprising:
a wheel coupled to a reducer;
a drive motor connected to the reducer; and
the reducer, wherein the reducer is connected at each end to the drive motor and the wheel, and the reducer decelerates and increases a torque of an output of the drive motor and feeds the output of the drive motor to the wheel;
wherein the reducer and the drive motor are built into the wheel; external support points of the wheel structure with the built-in reducer and motor are located at an outermost of two ends of the wheel structure as a whole, in a form of a simply supported beam structure.

2. The wheel structure according to claim 1, wherein the wheel comprises a hub and a tyre, the hub has a hollow structure with an offset “I” shape in a cross-section and vertical spokes offset in a middle to provide a strength support;
the vertical spokes divide a space inside the wheel into two different volumes of a hub cavity to house the drive motor and the reducer, respectively.

3. The wheel structure according to claim 2, wherein the inner cavity gradually increases in a diameter from inside to outside, providing a space for the motor and the reducer to be mounted while increasing an assembly clearance; and an outer cylindrical surface of the hub has grooves for bonding the tyres.

4. The wheel structure according to claim 1, wherein the drive motor is a high power motor in a small diameter, the drive motor is sized, and the drive motor is allowed to be arranged inside the wheel.

5. The wheel structure according to claim 1, wherein the reducer is a planetary reducer comprising a gear ring holder, a ring bearing, an inner gear ring, a gear ring holder, a wheel planetary holder, an outer planetary holder, a sun gear, a retaining ring, a sun gear shaft, a motor output shaft, a pressure plate, a key, a planetary holder flange bearing, a gear ring holder flange bearing, a planetary gear shaft, a planetary gear flange bearing, a planetary gear, and wheel flange bearings;
the motor output shaft of the drive motor is connected to the sun gear shaft by pressing a D-shaped shaft located at an end of the motor output shaft by means of the pressure plate, the sun gear shaft is connected to the sun gear co-axially by means of the key, a sun gear end face is provided with the axially restrained retaining ring;
the outer planetary holder and the wheel planetary holder are connected to the hub by means of countersunk screws, the planetary gear is restrained to the planetary gear shaft by means of two planetary gear flange bearings, the planetary gear shaft is connected to an outer planetary gear and a wheel planetary gear, and the planetary gear is restrained between the outer planetary gear and the wheel planetary gear;
the inner gear ring and a wheel gear ring holder are attached to a ring mounting bracket by means of hexagon socket screws.

6. The wheel structure according to claim 5, wherein the wheel is coaxially constrained to the motor output shaft by means of a wheel flange bearing, the wheel gear ring holder is coaxially constrained to the wheel planetary holder by means of a gear ring bearing, the outer planetary holder is coaxially constrained to the sun gear shaft by means of the planetary holder flange bearing, and the sun gear shaft is coaxially constrained to the gear ring holder by means of a gear ring holder flange bearing.

7. The wheel structure according to claim 5, wherein the planetary reducer has the inner gear ring as a fixed end, the sun gear as an input end and the wheel planetary holder as an output end, the sun gear engages with the planetary gear, the planetary gear engages with the inner gear ring, and the sun gear drives the planetary gear to rotate forward on the fixed inner gear ring when the sun gear rotates, driving the wheel planetary holder to decelerate the output coaxially with the sun gear; the input end of the planetary reducer is connected to the drive motor, the output end is connected to the wheel, and the fixed end serves as a support for the reducer.

8. The wheel structure according to claim 2, wherein a wheel size needs to be designed in conjunction with a tyre size, a wheel width is designed taking into account a tyre width, a drive motor width and a reducer width;
a width of a single tyre is set to a; the hub needs to be arranged with K tyres, wherein a hub width is A=ka (k is a positive integer); the hub width A needs to be designed, wherein a motor rotor and the reducer are arranged inside the hub;
outer dimensions of the hub are configured to match an inner diameter of the tyres, wherein the inner diameter is set as D; a maximum diameter of the inner cavity of the hub is d1, a minimum diameter of the inner cavity of the hub is d2 and a maximum diameter of the motor rotor is d,
wherein D>d₁>d₂>d;
considering that the space occupied by the motor in the inner cavity of the hub is larger and wider, a cantilever on a motor side of the hub is longer and has a largest deformation than a cantilever on a reducer side, with the largest deformation occurring at an outermost end of the cantilever on the motor side of the hub;
let an initial clearance at the outermost end of the cantilever on the motor side of the hub be u=d₁−d;
when the hub is deformed by a force, a clearance is always configured to be greater than zero, wherein a maximum hub deformation variable u₁<u.

9. The wheel structure according to claim 8, wherein a wheel design method analyses forces on the hub by means of a finite element analysis and selects a suitable hub material, wherein the suitable hub material meets strength and clearance requirements.
